(19) United States
(12) Patent Application Publication
(10) Pub. No.: US 2009/0064552 A1
(43) Pub. Date: Mar. 12, 2009

(54) Hitch-Mounted Vehicle Sign Display Assembly

(76) Inventor: John R. Columbia, Brownsville, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/207,640

(22) Filed: Sep. 10, 2008

Related U.S. Application Data
(60) Provisional application No. 60/993,130, filed on Sep. 10, 2007.

(51) Int. Cl. G09F 21/04

(52) U.S. Cl. 40/591

(57) ABSTRACT

A hitch-mounted vehicle sign display assembly of the present invention includes a shank configured to engage a conventional trailer hitch receiver and a support member (such as a framework) attached to the shank for attaching a display, such as a conventional yard sign or rigid sign, to the hitch receiver or hitch assembly of a vehicle.

### CROSS-REFERENCE TO RELATED APPLICATION

This application claims the benefits of U.S. Provisional Application No. 60/993,130 filed Sep. 10, 2007, which is herein incorporated by reference in its entirety.

### BACKGROUND OF THE INVENTION

1. Field of the Invention

The present invention relates generally to trailer hitch accessories and, more particularly, to a hitch-mounted vehicle sign display assembly.

2. Technical Considerations

Two popular sign display-type products in use throughout the United States and world are bumper stickers and yard signs. Both of these products are inexpensive and highly effective in conveying messages and/or demonstrating support of a particular political party, candidate, cause, initiative, athletic team, organization, school, etc.

Some individuals, however, refrain from attaching self-adhesive bumper stickers or magnetic stickers, decals, or signs to their vehicle owing to potentially damaging the finish of their vehicle. In addition, due to their limited size, bumper stickers can be hard to read unless one is very close to the display.

Yard signs are a very popular product, particularly among political candidates and/or political parties during a political campaign. Candidates and organizations strive to have, and appreciate, supporters placing yard signs on their property near the roadway where passing motorists can observe the signs and presumably conclude that the homeowner supports the individual whose sign is being displayed. Oftentimes, however, yard signs are placed anywhere along the sides of roadways and, thus, a sign placed in someone's yard does not necessarily mean that they endorse or support the team, organization, candidate, cause, initiative, expression, etc. being promoted. Yard signs are advantageous in that they are much larger than bumper stickers and are visible from a much greater distance. Most people, however, don't live along major roadways and, thus, exposure to yard signs they may have displayed may be limited to just a few observers.

The present invention overcomes the shortcomings described above and combines the benefits of bumper stickers and yard signs by providing an inexpensive vehicle hitch-mounted sign display assembly that accommodates the attachment of corrugated plastic, poly bag, wood and other conventional yard signs to a vehicle.

### SUMMARY OF THE INVENTION

A hitch-mounted vehicle sign display assembly includes a shank configured to engage a conventional trailer hitch receiver and a support member (such as a framework) attached to the shank for attaching a display, such as a conventional yard sign or similar sign, to the hitch receiver or hitch assembly of a vehicle.

These and other aspects of the present invention will become readily apparent upon further review of the following specification and drawings. The hitch-mounted vehicle sign display assembly described and illustrated in the drawings is intended to be illustrative and not exhaustive and the invention is not limited to the specific embodiments shown in the drawings.

### BRIEF DESCRIPTION OF THE DRAWINGS

FIG. 1 is a rear, perspective view of a hitch-mounted vehicle sign display assembly of the invention attached to a vehicle's hitch receiver;

FIG. 2 is an exploded rear, perspective view of the hitch-mounted vehicle sign display of FIG. 1; and

FIG. 3 is a rear view of another embodiment of the invention.

### DETAILED DESCRIPTION OF THE PREFERRED EMBODIMENTS

As used herein, spatial or directional terms, such as “top,” “bottom,” “left,” “right,” “over,” “under,” “front,” “rear,” and the like, relate to the invention as it is shown in the drawing figures. However, it is to be understood that the invention can assume various alternative orientations, and, accordingly, such terms are not to be considered as limiting.

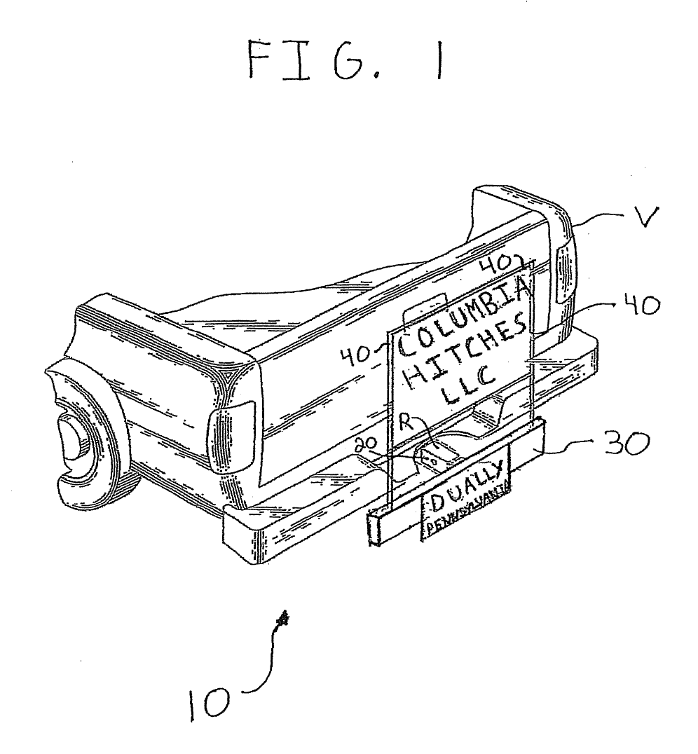

Referring to FIG. 1, there is shown an environmental perspective view of a first embodiment of the inventive hitch-mounted vehicle sign display assembly 10. The sign display assembly 10 is shown mounted to a vehicle's existing receiver hitch R (shown as a pick-up truck) by a hitch attachment shank 20 and secured to the vehicle's receiver R with a standard hitch pin (not shown). The hitch receiver R is mounted on the vehicle V in any conventional manner.

The vehicle sign display assembly's hitch attachment shank 20 serves as the display assembly's mounting shank for attaching to the vehicle by being inserted into the vehicle's hitch receiver R. The sign display assembly support member 30 is attached to the hitch attachment shank 20 and can extend perpendicularly therefrom. The support member 30 houses or supports a frame 40, which is used for attaching various types of conventional signage, such as but not limited to yard signs, to the assembly 10.

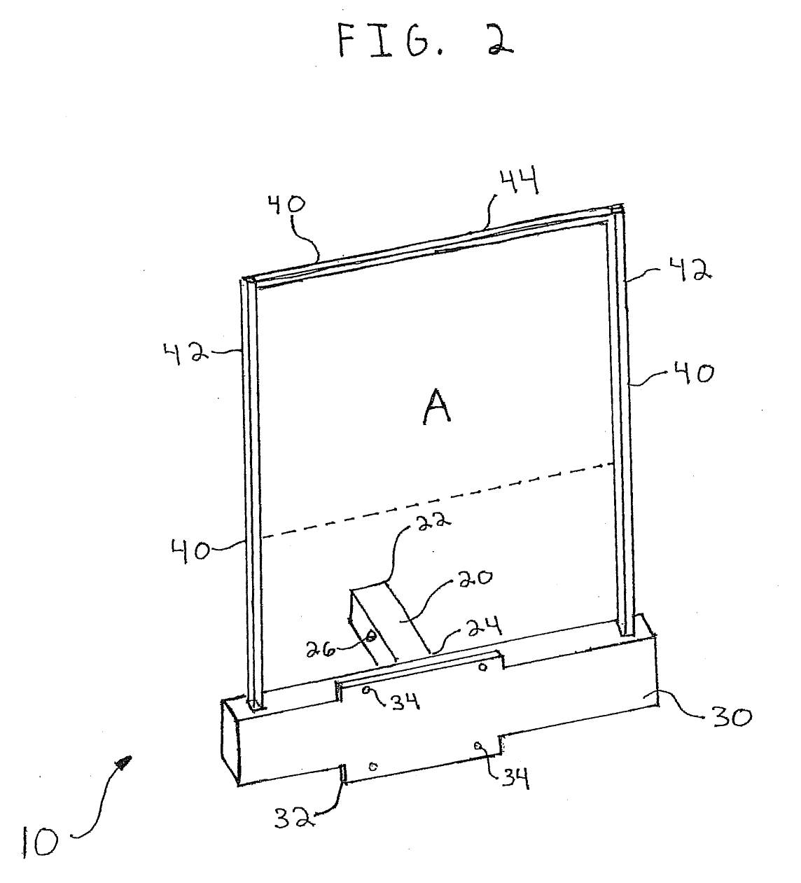

Referring to FIG. 2, there is shown an exploded rear perspective view of the hitch-mounted vehicle sign display of the embodiment of FIG. 1.

The sign display assembly's hitch attachment shank 20 is square, although other shapes may be used, and has a forward end portion 22 and rearward end portion 24. The forward end portion 22 serves as the sign display's mounting shank for inserting into the vehicle's receiver R and has hitch pin bore 26 for securing the sign display assembly 10 to the vehicle V, e.g., with a standard hitch pin. The rearward end portion 24 serves as a mount to support or connect the support member 30 to the shank 20. The support member 30 may be of a round, square, rectangular or other suitable shape and may be solid or hollow in form. Recognizing that there may be applications wherein the sign obstructs or partially obstructs the view of the vehicle's license plate, the support member 30 may comprise a surface area or plate 32 for relocating the vehicle's license plate and mounting it to the sign display assembly 10 where the vehicle's license plate can be clearly visible. The license plate mounting surface area 32 may have predrilled apertures 34 that align with the apertures in a standard license plate to accommodate the easy relocation and installation of the vehicle's license plate.

The sign display assembly's frame 40 may be round, square, rectangular or any other suitable shape, and is attached to the support member 30. In the illustrated embodiment, the frame 40 is comprised of opposed sides 42 and top 44. The sign display assembly's frame 40 may be a perimeter-type frame as shown with side frame members 42 and top frame member 44. The side frame members 42 are attached to the support member 30. With this type of frame, the area A between the side frame members 42 and between the top frame member 44 and the support member 30 is a hollow, open cavity, similar to conventional wire frames customarily used with poly bag yard signs.

The support member 30 may be configured to simply attach a complete yard sign (including the sign and a conventional wire frame) to the support member 30.

Alternatively, the sign display assembly's frame 40 may be one solid piece connected to the support member 30 leaving no open cavity in area A. Or, the frame 40 may be configured to include both hollow and solid areas between the frame sides 42, frame top 44 and frame support member 30. For example, area A may be solid between the frame sides 42 above the illustrated dotted line, but open beneath the dotted line to maintain an unobstructed view of the vehicle's license plate when applicable.

The shank 20, support member 30 and frame 40 can be made of plastic, metal, aluminum, steel, wood, styrofoam or any other appropriate material, or combination of materials. The length, width, height and thickness of the shank 20, support member 30 and frame 40 may be shortened or lengthened and the distance between all component parts may be increased or decreased as desired to accommodate the attachment of various sized conventional yard signs.

The hitch-mounted vehicle sign display assembly 10 may be formed as one solid assembly or may be constructed from two or more component pieces to be assembled together. The easy on/off hitch-mounted vehicle sign display assembly 10 of the present invention can attach and detach from the vehicle using a standard hitch pin and the support member 30 can serve as an attachment base for the frame 40 that houses or supports the display sign.

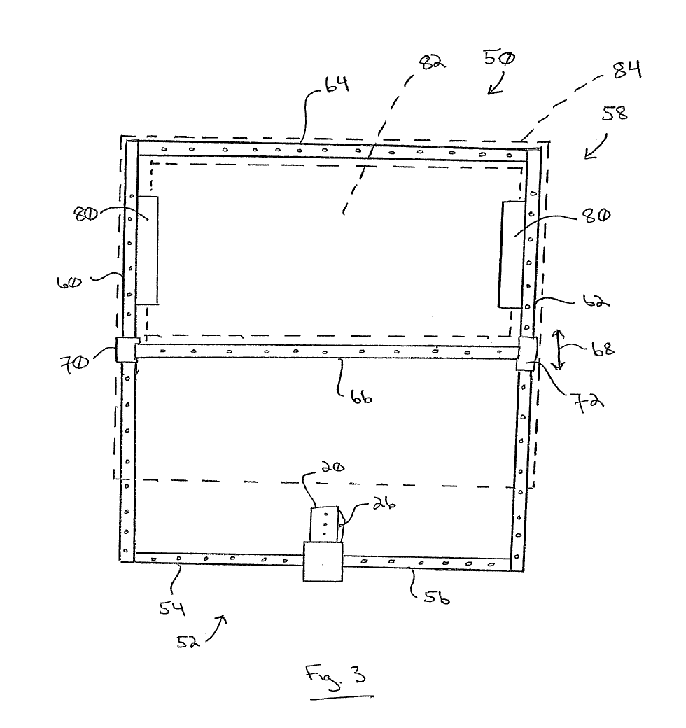

Another display assembly 50 incorporating features of the invention is shown in FIG. 3. The display assembly 50 includes a support or base 52 which, in the illustrated embodiment, includes a first base member 54 connected to or extending from one side of the shank 20 and a second base member 56 connected to or extending from the other side of the shank 20. The base 52 can be a single piece of a predetermined length attached to the shank 20. Alternatively, the base 52 can be adjustable in length. For example, the base members 54 and 56 can be adjustable, e.g., telescopic, such that the overall length of the base 52 can be adjusted. For example, the base members 54 and 56 can include a series of holes or bores which can be locked at a particular length by a conventional locking device, such as a conventional locking pin.

A frame 58 is connected to the base 52. In the illustrated embodiment, the frame 58 includes a pair of spaced side members 60 and 62 and a top member 64. The side members 60, 62 can also be either a predetermined length or can be adjustable in length (e.g., telescoping) such that the height of the frame 58 is adjustable. Additionally, the top member 64 can either be of a predetermined length or can be adjustable in length.

The frame 58 further includes at least one cross member 66. The cross member 66 can be permanently affixed to the side members 60, 62 or, in another embodiment, the cross member 66 can be vertically adjustable as shown by the arrow 68 along the side members 60, 62. For example, the ends of the cross member 66 can be connected to slidable members 70, 72 that can slide up and down along the side members 60, 62 and can be selectively locked in place by any conventional method, such as, but not limited to, a locking pin engaging holes in the side members 60, 62. Additionally, the frame 58 can include a pair of opposed sign holders 80 attached to the side members 60, 62. In one non-limiting embodiment, the sign holders 80 can be formed by U-shaped channels connected to the side members 60, 62 and configured to engage a rigid sign (shown by dashed lines 82).

Thus, to place a rigid sign 82 in the frame 58, the cross member 66 can be lowered and the sign 82 placed in the sign holders 80. The cross member 66 can then be raised and locked in place to hold the sign 82 in place.

Alternatively, for use with a conventional yard sign (shown by dashed lines 84), the width and/or heighth of the frame 58 can be adjusted and the yard sign 84 slipped over the frame 58. As will be appreciated, a conventional yard sign 84 typically has the form of a large sleeve or bag having an open end. The open end can be slid down over at least a portion of the frame 58 so that the writing or other indicia on the yard sign 84 faces outwardly. If desired, the yard sign 84 can be attached to the frame 58 (such as by ties or an elastic strap).

It is to be understood that the present invention is not limited to the embodiments described above but encompasses any and all embodiments within the scope of the following claims. For example, modifications to the support member to facilitate the connection of the invention to portions of a vehicle other than the hitch receiver using magnets or suction cups are also anticipated and considered within the scope of this application.

The invention claimed is:

1. A vehicle sign display assembly, comprising:
an attachment shank configured to engage a vehicle hitch receiver;
a support member connected to the shank; and
a frame mounted on the support member and configured to support a sign.

2. The display assembly of claim 1, wherein the support member is of uniform length.

3. The display assembly of claim 1, wherein the support member is adjustable in length.

4. The display assembly of claim 1, wherein the frame includes a pair of opposed side members and a top member.

5. The display assembly of claim 4, wherein the side members are adjustable in length.

6. The display assembly of claim 4, wherein the top member is adjustable in length.

7. The display assembly of claim 4, including a cross member extending between the opposed side members.

8. The display assembly of claim 7, wherein the cross member is moveable along the side members.

9. The display assembly of claim 7, wherein the cross member is adjustable in length.

10. The display assembly of claim 1, wherein the sign is a conventional yard sign.
